(19) United States
(12) Patent Application Publication
(10) Pub. No.: US 2012/0055036 A1
(43) Pub. Date: Mar. 8, 2012

(54) APPARATUS AND METHOD FOR SURFACE MARKING AT AN OUTSIDE CORNER

(76) Inventor: Harry Carl BOWMAN, Friendswood, TX (US)

(21) Appl. No.: 13/150,374

(22) Filed: Jun. 1, 2011

Related U.S. Application Data
(60) Provisional application No. 61/379,657, filed on Sep. 2, 2010.

(51) Int. Cl. B43L 13/02

(52) U.S. Cl. 33/449; 33/448

(57) ABSTRACT

An apparatus and method for surface marking along an outside corner. In one embodiment, a marking tool includes a base portion and a marker retention portion. The base portion includes a first end and a second end along a longitudinal axis of the tool. The base portion includes a base surface along the longitudinal axis. The base surface is configured to movingly engage a first surface. The marker retention portion extends from the first end of the base portion. The marker retention portion is configured to retain a marking device and to position a marking face of the marking device to engage a second surface that intersects the first surface at an outside corner.

### CROSS-REFERENCE TO RELATED APPLICATION

The present application claims priority to U.S. Provisional Patent Application No. 61/379,657, filed on Sep. 2, 2010; which is hereby incorporated herein by reference in its entirety.

### BACKGROUND

When applying coverings or coatings, such as paint, to a wall it is usually desirable for transitions from one covering type or color to a different covering type or color to occur at a uniform boundary, such as a straight line. Various tools have been devised for marking such boundaries. Chalk lines and laser projectors are examples of devices that can be used to mark straight lines on walls or other surfaces.

In modern construction, rounded corners are often employed where one wall meets another and/or in recessed ceilings. Rounded corners are achieved using bullnose corner beads of various radii. While rounded corners are aesthetically pleasing, drawing a straight line on the rounded corner to separate surfaces to be colored, or otherwise finished, differently can be difficult. A laser tool can be used to project a straight line on a surface in some cases, but a laser tool can be expensive and may require expertise that many users (e.g., homeowners) lack. Tape can be used to separate two colors but without a straight reference for applying the tape, taping may result in crooked and unsightly paint lines. Thus, there exists a need for improved tools and methods for providing uniform wall markings.

### SUMMARY

An apparatus and method for surface marking along an outside corner. In one embodiment, a marking tool includes a base portion and a marker retention portion. The base portion includes a first end and a second end along a longitudinal axis of the tool. The base portion includes a base surface along the longitudinal axis. The base surface is configured to movingly engage a first surface. The marker retention portion extends from the first end of the base portion. The marker retention portion is configured to retain a marking device and to position a marking face of the marking device to engage a second surface that intersects the first surface at an outside corner.

In another embodiment, a method for marking a surface around an outside corner includes engaging a base portion of a tool with a surface of a first wall. A marking face of the tool is engaged with a surface of a second wall connected to the first wall at the outside corner. The tool is moved along the outside corner while maintaining the engaging with the surface of the first and second walls. The marker retention portion of the tool laterally extends from a first end of a base portion of the tool. The marking face of the marker extends towards a second end of the base portion of the tool longitudinally disposed from the first end.

In a further embodiment, a tool for around-corner marking includes a handle and a marker retention member. The handle has a surface configured to engage a first wall forming the corner. The marker retention member extends laterally from a first end of the handle. The marker retention member is configured to position a marking implement against a second wall forming the corner. The first and second walls form a reflex angle at the corner.

### BRIEF DESCRIPTION OF THE DRAWINGS

For a detailed description of exemplary embodiments of the invention, reference will now be made to the accompanying drawings in which:

FIGS. 1A-1C show application of a tool to mark a surface at an outside corner in accordance with various embodiments;

FIG. 2 shows views of the tool for marking a surface at an outside corner in accordance with various embodiments;

FIG. 3 shows a tool for marking a surface at an outside corner that includes a marker clamp in accordance with various embodiments;

FIGS. 4A-4B show a tool for marking a surface at an outside corner that includes surface rollers in accordance with various embodiments;

FIG. 5 shows a tool for marking a surface at an outside corner that includes variable marker extension in accordance with various embodiments; and

FIG. 6 shows a flow diagram for a method for marking a surface at an outside corner in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Separating areas of different wall coloring and/or other surface treatment at a straight line can be difficult, and especially so at rounded corners. Embodiments of the present disclosure allow a reference line to be drawn on a first surface at a uniform distance from a second surface, thereby producing a reference line having uniform distance from an outside corner.

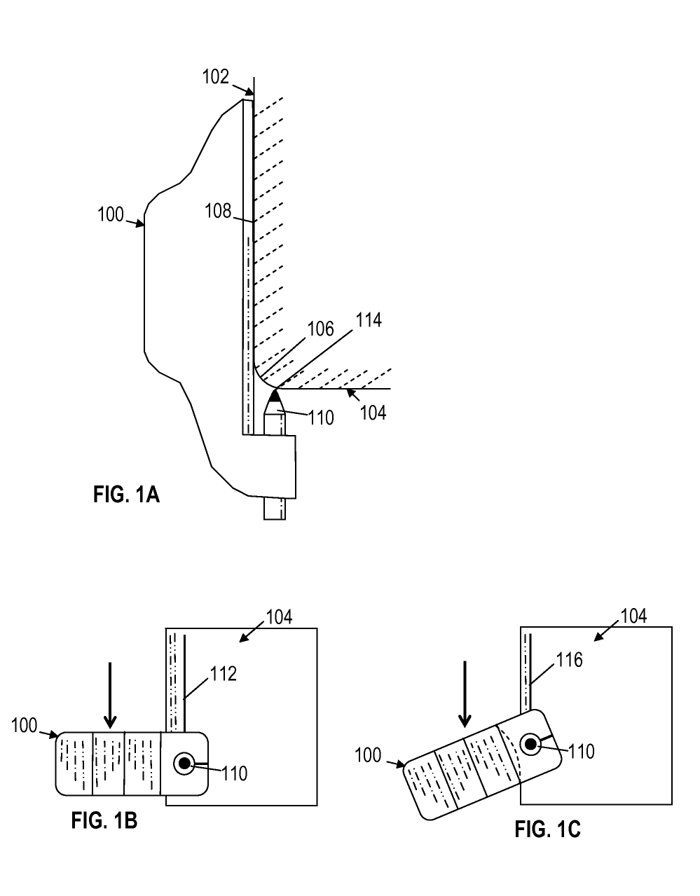

FIGS. 1A-1C show application of the tool 100 to mark a surface at an outside corner in accordance with various embodiments. FIG. 1A shows the tool 100 disposed to place a mark on the surface 104. Surfaces 102 and 104 intersect at the outside corner 106. The surfaces 102 and 104 may be the surfaces of walls, for example, that intersect at an outside corner. The base surface 108 of the tool 100 engages the surface 102 and the marking device 110 of the tool 100 engages the surface 104. The tool 100 is moved longitudinally along the outside corner 106, as shown in FIG. 1B. As the tool 100 is so moved, the base surface 108 and the marking device 110 continuously engage the surface 102 and the surface 104 respectively, and the contact of the marking device 110 with the surface 104 forms a mark 112 on the surface 104 at a consistent distance from the surface 102 as shown in FIG. 1B. In at least some embodiments, the tool 100 is configured to place the mark 112 of the surface 104 at a point where the surface 104 is tangent to the radius of curvature of the corner 106.

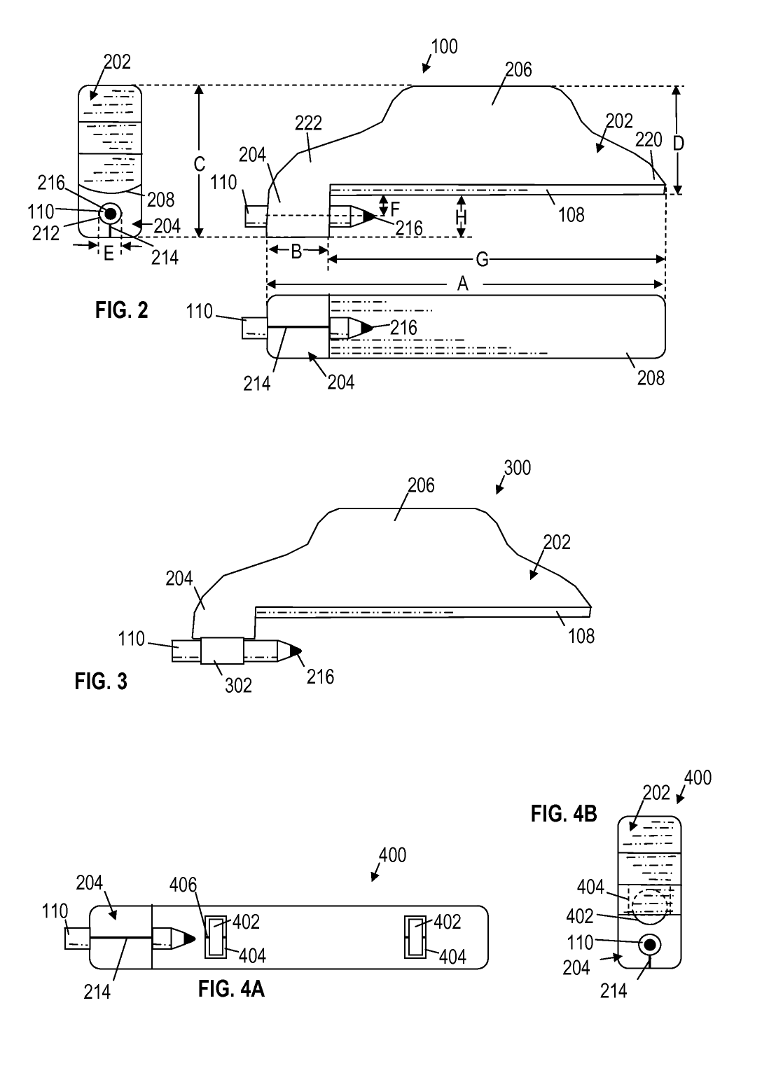

FIG. 2 shows views of the tool 100 for marking a surface at an outside corner in accordance with various embodiments. The tool 100 includes a base portion 202 and a marker retention portion 204. The base portion 202 forms a handle 206 grippable by a user for moving the tool 100 along a first surface (e.g., the surface 102, where the surface 102 may be a wall surface, a ceiling surface, etc), and extends from a first end 222 to a second end along a longitudinal axis of the tool 100. The base portion 202 also includes a base surface 108. In some embodiments, the base surface 108 is configured to engage the first surface as the user moves the tool 100. The base surface 108, as well as other portions of the tool 100, may be formed of a material that slides easily along the first surface and leaves no marks or surface damage as the tool 100 moves (e.g., nylon, polytetrafluoroethylene, wood, metal, non-marring plastic, etc). In some embodiments, the base surface 108 may be curved (e.g., semicylindrical) to allow for smooth movement of the tool 100 along the first surface and to allow the tool 100 to be non-normally oriented while positioned against the first surface.

The marker retention portion 204 extends from the base portion 202. In some embodiments, the marker retention portion 204 extends from the first end 222 (e.g., a proximal end) of the base portion 202. In some embodiments, the marker retention portion 204 extends generally perpendicularly from the base portion 202. The marker retention portion 204 of the tool 100 is configured to hold a marking device 110. The marking device 110 may be a pencil, a pen, a paint applicator, or any other device or implement suitable for marking on a surface. The marker retention portion 204 is configured to hold the marking device 110 such that a marking face 216 (e.g., a tip or end) of the marking device 110 extends towards the second end 220 (e.g., a distal end) of the base portion 202, thereby allowing the marking device 110 to place a mark, referenced to the first surface, on a second surface when the first and second surfaces intersect at a reflex angle, such as at the outside corner 106.

In the embodiment of FIG. 2, the retention portion 204 includes an integral clamp to hold the marking device 110 in place. The marking device 110 is inserted into a passage 212 through the retention portion 204. A slit 214 between the passage 212 and the exterior of the retention portion 204 provides flexibility for inserting and securely retaining the marking device 110 in the retention portion 204. Some embodiments may use a set screw or other retaining mechanism to hold the drawing tool 110 in place. Exemplary approximate dimensions of the tool 100, as shown in FIG. 1, include:

| | |
|---|---|
| Overall Length (A) | ≈ 6 13/16 inches |
| Retention Portion Length (B) | ≈ 1¼ inches |
| Overall Height (C) | ≈ 3½ inches |
| Base Portion Height (D) | ≈ 2½ inches |
| Marking Device Passage (E) | ≈ 9/32 inches |
| Base Surface to Passage Centerline (F) | ≈ 11/16 inches |
| Base Surface Length (G) | ≈ 5 9/16 inches |
| Retention Portion Height (H) | ≈ 1 inch |

Other embodiments may be dimensioned differently. For example the passage 212 may be approximately 19/64 inches in diameter, or may have another diameter suitable to retain the drawing device 110.

In some embodiments of the tool 100, the exemplary dimensions may include:

| | |
|---|---|
| Overall Length (A) | ≈ 200% Overall Height |
| Retention Portion Length (B) | ≈ 20% Overall Length |
| Overall Height (C) | ≈ 50% Overall Length |
| Base Portion Height (D) | ≈ 70% of Overall Height |
| Marking Device Passage (E) | Dependent of Marking Device |
| Base Surface to Passage Centerline (F) | Dependent on Corner Bead |
| | radius |
| Base Surface Length (G) | ≈ 80% of Overall Length |
| Retention Portion Height (H) | ≈ 30% of Overall Height |

As mentioned above, the base surface 108 may be curved to allow the tool 100 to be tilted. By tilting the tool 100 (i.e. changing the pitch of the tool 100 relative to the first surface), the distance between the first surface and the marking face 216 can be adjusted. Thus, the curved surface 108 allows the distance between the first surface and a reference mark drawn on a second surface to be changed by tilting the tool 100. FIG. 1C shows the tool 100 tilted relative to surface 102, resulting in the mark 116 being closer to the surface 102 than is the mark 112 of FIG. 1B where the tool 100 is normal to the surface 102.

FIG. 3 shows a tool 300 for marking a surface at an outside corner that includes a marker clamp 302 in accordance with various embodiments. The tool 300 is similar in many respects to the tool 100 described above. However, rather than the passage 212, the tool 300 includes an external clamp 302 for holding the marking device 110. The clamp 302 may be a metal or plastic clamp (e.g., a pencil clamp) as is known in the art. In some embodiments of the tool 300, the clamp 302 may be removable and replaceable to allow clamps of different sizes and configurations to be fixed to the tool 300. For example, one embodiment of the clamp 302 may hold a pencil, and another embodiment of the clamp 302 may hold a different size marker, such as a paint applicator, and either clamp may be removably attached to the retention member 204. Any method of fixing one component to another may be used to fix the clamp 302 to the retention member 204 (e.g., adhesive, screws, clips, etc).

FIGS. 4A and 4B show a tool 400 for marking a surface at an outside corner that includes surface rollers 402 in accordance with various embodiments. The tool 400 is similar in many respects to the tool 100 described above. However, rather than engaging a surface via the curved base surface 108, the base surface of the tool 400 includes rollers 402 that engage and provide smooth tool movement over the surface. Each roller 402 is disposed on an axle 406 in a recess 404. The tool 400 may include any number of rollers 402. In some embodiments of the tool 400, the rollers 402 may be spherical.

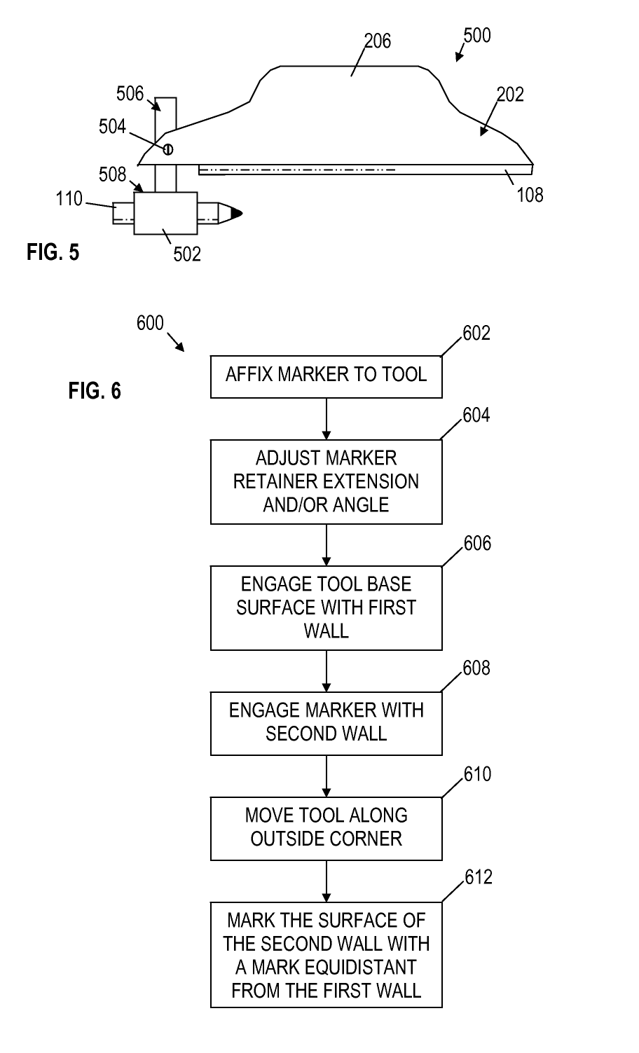

FIG. 5 shows a tool 500 for marking a surface at an outside corner that includes variable marker extension in accordance with various embodiments. The tool 500 is similar in many respects to the tool 100 described above. However, rather than fixing the distance from the base surface 108 to the centerline of the passage 212 (i.e., distance from the base surface 108 to the marking face 216), the tool 500 includes a retention member 508 that can be variably extended from the base portion 202. The retention member 508 includes a retainer 502 for retaining the marking device 110, and an extension member 506. The retainer 502 may be equivalent to the clamp 302. The extension member 506 extendably couples the retainer 502 to the base portion 202. For example, the extension member 506 may pass through a passage in the base portion 202 and be fixed in place by a set screw 504 (or any other means of variable fixing the position of a component with respect to another component). In some embodiments, the angle of the retention member 508 is adjustable relative to the body portion 202. Thus, the tool 500 is configured to draw a mark on a second surface at a varying distance from the surface engaged by the base portion 202 (e.g., to accommodate various bullnose bead radii).

In some embodiments of the tool 500, the base surface 108 may be flat and of sufficient width to inhibit tilting of the tool 500 as the tool is moved along the surface 102, thereby facilitating tool stability and provision of a mark consistently spaced from the surface 102. Similarly, some embodiments may include rollers disposed to laterally stabilize the tool 500.

FIG. 6 shows a flow diagram for a method for marking a surface at an outside corner in accordance with various embodiments. Though depicted sequentially as a matter of convenience, at least some of the actions shown can be performed in a different order and/or performed in parallel. Additionally, in some embodiments of the method 600, only some of the operations shown may be performed.

In block 602, a marker 110 is affixed to the tool 100. The marker 110 may be a pencil, a pen, a paint applicator, a pencil lead, etc. The marker may be affixed to the tool by various means, for example, by clamping, a set screw, or other means known in the art.

In block 604, the extension and/or the angle of the retainer 502 is adjusted relative to the body portion 202. The adjustment positions the marking device 110 relative to the body portion 202 to place a mark on the surface 104 at a desired offset from the surface 102. The extension and/or angle adjustment may be accomplished by loosening the set screw 504, repositioning the retaining member 508, and tightening the set screw 504, or by other means of changing the position of the retainer 502 relative to the body portion 202 known in the art.

In block 606, base surface 108 of the tool 100 engages the surface 102. The base surface 108 may be flat, curved or rounded, and/or may include rollers 402. The marker 110 engages the surface 104 in block 608.

In block 610, the tool 100 is moved longitudinally along the outside corner 106 as the base surface 108 engages the surface 102 and the marker 110 engages the surface 104. As the tool 100 moves along the corner 106, the marker 110 places a mark 112 on the surface 104 in block 612. The mark 112 is substantially equidistant from the surface 102 over the extent of the movement of the tool 100.

The above discussion is meant to be illustrative of the principles and various embodiments of the present invention. Numerous variations and modifications will become apparent to those skilled in the art once the above disclosure is fully appreciated. For example, various features shown in the tools 100, 300, 400, and 500 are interworkable and can be integrated in embodiments of the marking tool 100 as desired. It is intended that the following claims be interpreted to embrace all such variations and modifications.

What is claimed is:

1. A marking tool, comprising:
a base portion having a first end and a second end along a longitudinal axis of the tool, the base portion comprising a base surface, along the longitudinal axis, configured to movingly engage a first surface; and
a marker retention portion extending from the first end of the base portion, the marker retention portion configured to retain a marking device and to position a marking face of the marking device to engage a second surface intersecting the first surface at an outside corner.

2. The marking tool of claim 1, wherein the marker retention portion extends from the base portion along an axis normal to the longitudinal axis.

3. The marking tool of claim 1, wherein the marker retention portion is configured to retain the marking device along an axis parallel to and offset from the longitudinal axis.

4. The marking tool of claim 1, wherein the base surface is curved about the longitudinal axis.

5. The marking tool of claim 1, wherein the base surface comprises rollers configured to engage the first surface.

6. The marking tool of claim 1, wherein the marker retention portion is variably extendable from the base portion.

7. The marking tool of claim 1, wherein the tool is configured to produce a mark on the second surface over a range of engaged movement along the first surface, the mark being equidistant from the first surface over the range of engaged movement.

8. The marking tool of claim 1, wherein the retention portion is configured to dispose the marking face of the marking tool at a point where the second surface is tangent to the radius of curvature of a corner where the first surface and the second surface intersect.

9. A method for marking a surface around an outside corner, the method comprising:
engaging a base portion of a tool with a surface of a first wall;
engaging a marking face of the tool with a surface of a second wall connected to the first wall at the outside corner; and
moving the tool along the outside corner while maintaining the engaging with the surface of the first and second walls;
wherein the marker retention portion of the tool laterally extends from a first end of a base portion of the tool, and the marking face of the marker extends towards a second end of the base portion of the tool longitudinally disposed from the first end.

10. The method of claim 9, further comprising marking the surface of the second wall, responsive to the moving, with a mark equidistant from the surface of first wall over the extent of the moving.

11. The method of claim 9, further comprising adjusting extension of the marker retention portion of the tool from the base portion of the tool thereby setting a distance between an engagement point of the marking face with the second wall and the surface of the first wall.

12. The method of claim 9, wherein the outside corner comprises a bull-nose corner bead.

13. The method of claim 9, wherein the engaging the base portion with the surface of the first wall comprises engaging rollers disposed in the base portion with the surface of the first wall.

14. The method of claim 9, further comprising affixing a marker to the marker retention portion of a tool, the marker comprising the marking face.

15. The method of claim 9, further comprising adjusting an angle of the base portion of the tool relative to the first surface, thereby setting a distance between an engagement point of the marking face with the second wall and the surface of the first wall.

16. A tool for around-corner marking, the tool comprising:
a handle having a surface configured to engage a first wall forming the corner;
a marker retention member extending laterally from a first end of the handle;
wherein the marker retention member is configured to position a marking implement against a second wall forming the corner, and the first and second walls form a reflex angle at the corner.

17. The tool of claim 16, wherein the marker retention member comprises a marker clamp that fixes the marking implement to the tool.

18. The tool of claim 16, wherein the handle comprises rollers configure to engage the first wall.

19. The tool of claim 16, wherein the marker retention member is one of laterally and angularly adjustable relative to the handle.

20. The tool of claim 16, wherein the surface configured to engage the first wall is curved.
